(19) United States
(12) Patent Application Publication
(10) Pub. No.: US 2018/0174576 A1
(43) Pub. Date: Jun. 21, 2018

(54) ACOUSTIC-TO-WORD NEURAL NETWORK SPEECH RECOGNIZER

(71) Applicant: Google LLC, Mountain View, CA (US)

(72) Inventors: Hagen Soltau, Yorktown Heights NY, NY (US); Hasim Sak, New York, NY (US); Hank Liao, New York, NY (US)

(21) Appl. No.: 15/834,254

(22) Filed: Dec. 7, 2017

Related U.S. Application Data
(60) Provisional application No. 62/437,470, filed on Dec. 21, 2016.

(51) Int. Cl. G10L 15/16; G06N 3/04; G06N 3/08; G10L 15/02; G10L 15/22; G10L 15/14; G10L 21/10; G10L 15/06

(52) U.S. Cl. CPC G10L 15/16; G06N 3/0445; G06N 3/084; G10L 15/063; G10L 15/22; G10L 15/14; G10L 21/10; G10L 15/02

(57) ABSTRACT

Methods, systems, and apparatus, including computer programs encoded on computer storage media for large vocabulary continuous speech recognition. One method includes receiving audio data representing an utterance of a speaker. Acoustic features of the audio data are provided to a recurrent neural network trained using connectionist temporal classification to estimate likelihoods of occurrence of whole words based on acoustic feature input. Output of the recurrent neural network generated in response to the acoustic features is received. The output indicates a likelihood of occurrence for each of multiple different words in a vocabulary. A transcription for the utterance is generated based on the output of the recurrent neural network. The transcription is provided as output of the automated speech recognition system.

### CROSS REFERENCE TO RELATED APPLICATION

The present application claims priority to U.S. Provisional Application No. 62/437,470 filed Dec. 21, 2016, which is incorporated herein by reference in its entirety.

### BACKGROUND

This specification relates generally to speech recognition and more specifically to speech recognition provided by neural networks.

Neural networks can be used in speech recognition. Typically, when neural networks are used for acoustic modeling, the neural network is used to predict sub-word units, such as phones or states of phones.

### SUMMARY

In general, one innovative aspect of the subject matter described in this specification can be embodied in methods that include the actions of receiving audio data representing an utterance of a speaker; providing acoustic features of the audio data to a recurrent neural network trained using connectionist temporal classification to estimate likelihoods of occurrence of whole words based on acoustic feature input; receiving output of the recurrent neural network generated in response to the acoustic features, the output indicating a likelihood of occurrence for each of multiple different words in a vocabulary; determining a transcription for the utterance based on the output of the recurrent neural network; and providing the transcription as output of the automated speech recognition system.

Other embodiments of this aspect include corresponding computer systems, apparatus, and computer programs recorded on one or more computer storage devices, each configured to perform the actions of the methods. A system of one or more computers can be configured to perform particular operations or actions by virtue of software, firmware, hardware, or any combination thereof installed on the system that in operation may cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. In some implementations, the recurrent neural network is trained as a speaker-independent recognizer for continuous speech.

In some implementations, the neural network is a bidirectional neural network that includes a plurality of forward-propagating long short-term memory layers and a plurality of backward-propagating long short-term memory layers.

In some implementations, the automated speech recognition system generates feature vectors that each include a set of mel-frequency coefficients for a different segment of the utterance. In some implementations, providing the acoustic features of the audio data to the recurrent neural network comprises providing the feature vectors as input to the recurrent neural network in a first sequence, and providing the feature vectors as input to the recurrent neural network in a second sequence having a reversed order of the first sequence.

In some implementations, the vocabulary comprises a predetermined set of words. In some aspects receiving the output of the recurrent neural network comprises receiving a set of probability scores that includes a probability score for each word in the predetermined set of words for each of multiple time steps.

In some implementations, the vocabulary comprises at least 1,000 words. In other implementations, the vocabulary comprises at least 10,000 words. In some implementations, the vocabulary comprises at least 50,000 words.

In some implementations, determining the transcription based on the output of the recurrent neural network comprises determining the transcription without using a beam search technique.

In some cases the speech recognition system is configured to not predict sub-word linguistic units.

In some implementations, receiving the output of the recurrent neural network comprises receiving a set of output values from the recurrent neural network for each of multiple time steps, wherein each set of output values includes a probability of occurrence for each of multiple words in a vocabulary.

In some implementations determining the transcription for the utterance based on the output of the recurrent neural network comprises determining, for each of multiple time steps, which word in the vocabulary has a highest probability of occurrence according to the set of output values for the time step.

In some implementations, receiving the audio data comprises accessing audio data from an Internet resource.

In some implementations, the transcription is provided as a caption for the audio data of the Internet resource.

Aspects of the subject matter described herein may provide end-to-end speech recognition with neural networks. More specifically, they may provide a simplified, large vocabulary continuous speech recognition system with whole words as acoustic units. The use of connectionist temporal classification (CTC) word models may facilitate an end-to-end model that does not use traditional context-dependent sub-word phone units that require a pronunciation lexicon, or any language model. As such, the speech recognition system may be simplified in that it does not include decoding based on a pronunciation lexicon and/or a language model. In addition, as will be explained in more detail below, the CTC word models described herein may perform better, in terms of word error rate, than a strong, more complex, state-of-the-art baseline with sub-word units.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example of a neural network speech recognition model.

FIG. 2 is a flow diagram of an example process for generating a transcription of audio data.

FIG. 3 is a block diagram that illustrates an example of a system for acoustic-to-word processing using recurrent neural networks.

FIG. 4 is a diagram that illustrates an example of speech recognition using neural networks.

FIG. 5 is a diagram that illustrates examples of structures of a recurrent neural network.

FIG. 6 shows an example of a computing device and a mobile computing device.

Like reference numbers and designations in the various drawings indicate like elements.

### DETAILED DESCRIPTION

Neural networks can be trained as acoustic models to classify a sequence of acoustic data. Often, acoustic models are used to generate a sequence of sub-word units or phones or phone subdivisions representing the acoustic data. To classify a particular frame or segment of acoustic data, an acoustic model can evaluate context, e.g., acoustic data for previous and subsequent frames, in addition to the particular frame being classified. For automatic speech recognition, the goal is to minimize the word error rate. One way to do this is to use words as units for acoustic modeling, instead of using sub-word units. With this approach, as discussed below, a neural network acoustic model can be trained to estimate word probabilities instead of probabilities of sub-word units.

Neural networks can be trained to perform speech recognition. For example, a neural network may be trained to classify a sequence of acoustic data to generate a sequence of words representing the acoustic data. To classify a particular frame or segment of acoustic data, an acoustic model can evaluate context, e.g., acoustic data for previous and subsequent frames, in addition to the particular frame being classified. In some instances, a recurrent neural network may be trained as a speaker-independent recognizer for continuous speech to label acoustic data using connectionist temporal classification (CTC). Through the recurrent properties of the neural network, the neural network may accumulate and use information about future context to classify an acoustic frame. The neural network is generally permitted to accumulate a variable amount of future context before indicating the word that a frame represents. Typically, when CTC is used, the neural network can use an arbitrarily large future context to make a classification decision. Powerful neural network models can be used with large amounts of training data can to build a neural speech recognizer (NSR) that can be trained end-to-end and can recognize words.

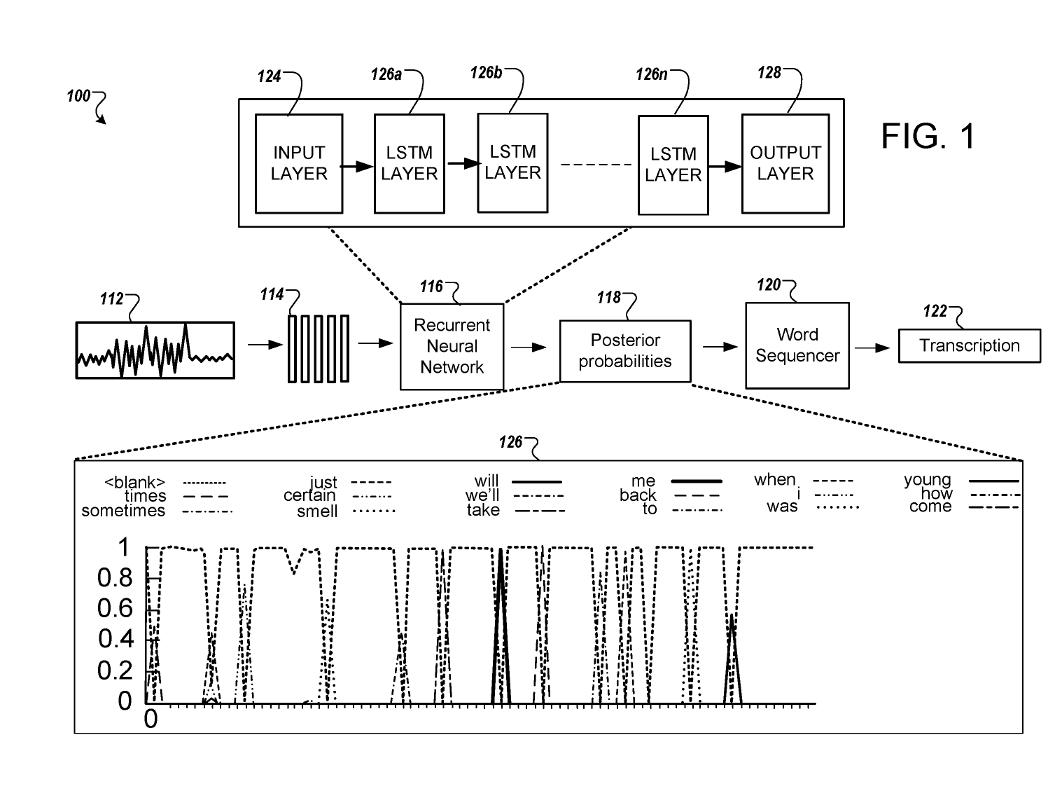

FIG. 1 illustrates an example transcription generation process 100 performed by a computing system. The computing system receives the audio data 112 and generates acoustic features 114 of the audio data. The acoustic features could be a set of feature vectors, where each feature vector indicates audio characteristics during a different portion or window of the audio data 112. Each feature vector may indicate acoustic properties of, for example, a 10 ms, 25 ms, or 50 ms frame of the audio data 112, as well as some amount of context information describing previous and/or subsequent frames. In the illustrated example, the computing system inputs the acoustic features 114 to the recurrent neural network 116. The recurrent neural network 116 has been trained to act as a model that outputs likelihoods that different words have occurred.

The recurrent neural network 116 produces neural network outputs 118, e.g., output vectors that together indicate a set of probabilities. Each output vector can be provided at a consistent rate, e.g., if input vectors to the neural network 116 are provided every 10 ms, the recurrent neural network 116 provides an output vector roughly every 10 ms as each new input vector is propagated through the recurrent neural network 116.

The neural network outputs 118 or the output indicating a likelihood, such as a posterior probability, of occurrence for each of multiple different words in a vocabulary. Plot 126 shows the word posterior probabilities as predicted by the NSR model at each time-frame (30 msec) for a segment of a music video. The missing words and the words with the highest posterior probabilities are plotted in 126.

The word sequencer 120 uses the neural network outputs 118 to identify a transcription 120 for the portion of an utterance.

The recurrent neural network 116 may be a deep LSTM (Long Short Term Memory) recurrent neural network architecture built by stacking multiple LSTM layers 126ₐ-126ₙ. The neural network may be a bidirectional neural network that includes a plurality of forward-propagating LSTM layers and a plurality of backward-propagating LSTM layers, with two LSTM layers at each depth—one operating in the forward and another operating in the backward direction in time over the input sequence. Both these layers at the same depth are connected to both previous forward and backward layers. This will be shown below in greater detail below.

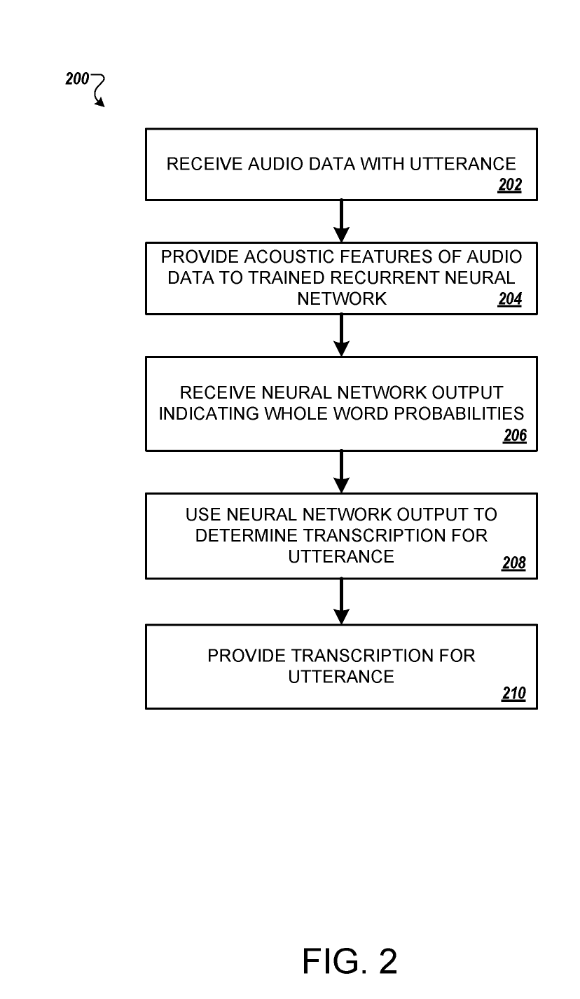

FIG. 2 is a flow diagram of an example process 200 for generating a transcription of audio data. For convenience, the process 200 will be described as being performed by a system of one or more computers located in one or more locations. For example, speech recognition system, such as the computing system described above, can perform the process 200.

Audio data that represents a portion of an utterance is received (202). In some implementations, the audio data is received at a server system configured to provide a speech recognition service over a computer network from a client device. In some implementations, the audio data is received from an Internet resource.

The audio data 112 can be divided into a series of multiple frames and the corresponding feature vectors may be determined. The multiple frames correspond to different portions or time periods of the audio data 112. For example, each frame may describe a different 25-millisecond portion of the audio data 112. In some implementations, the frames overlap, for example, with a new frame beginning every 10 milliseconds (ms). Each of the frames may be analyzed to determine feature values for the frames, e.g., MFCCs, log-mel features, or other speech features. For each frame a corresponding acoustic feature representation is generated. These representations are illustrated as feature vectors that each characterize a corresponding frame time step of the audio data 112. In some implementations, the feature vectors may include prior context or future context from the utterance. For example, the computer system 120 may generate the feature vector for a frame by stacking feature values for a current frame with feature values for prior frames that occur immediately before the current frame and/or future frames that occur immediately after the current frame. The feature values, and thus the values in the feature vectors, can be binary values.

The audio data may include a feature vector for a frame of data corresponding to a particular time step, where the feature vector may include values that indicate acoustic features of multiple dimensions of the utterance at the particular time step. In some implementations, multiple feature vectors corresponding to multiple time steps are received, where each feature vector indicates characteristics of a different segment of the utterance. For example, the audio data may also include one or more feature vectors for frames of data corresponding to times steps prior to the particular time step, and one or more feature vectors for frames of data corresponding to time steps after the particular time step.

Various modifications may be made to the techniques discussed above. For example, different frame lengths or feature vectors can be used. In some implementations, a series of frames may be samples, for example, by using only every third feature vector, to reduce the amount of overlap in information between the frame vectors provided to the neural network 116.

The audio data is provided to a trained recurrent neural network (204). The recurrent neural network may be a bi-directional neural network that includes a plurality of forward-propagating long short-term memory layers and a plurality of backward-propagating long short-term memory layers.

The trained recurrent neural network outputs indicating whole word probabilities (206). A set of output values from the recurrent neural network for each of multiple time steps may be received, wherein each set of output values includes a probability of occurrence for each of multiple words in a vocabulary. The vocabulary may comprise a predetermined set of words. The step of receiving the output of the recurrent neural network may comprise receiving a set of probability scores that includes a probability score for each word in the predetermined set of words for each of multiple time steps. Each output vector produced by the CTC output layer 128 may include a score for each respective word from a set of words and also a score for a “blank” symbol. The score for a particular word represents a likelihood that the particular word has occurred in the sequence of audio data inputs provided to the neural network 116. The blank symbol is a placeholder indicating that the neural network 116 does not indicate that any additional word has occurred in the sequence. Thus, the score for the blank symbol represents a likelihood or confidence that an additional word should not yet be placed in sequence.

The output of the trained recurrent neural network is used to determine a transcription for the utterance (208). For example, the output of the trained recurrent neural network may be provided to a word sequencer 120 of FIG. 1, which determines a transcription for the utterance. The step of determining the transcription for the utterance based on the output of the recurrent neural network may involve determining, for each of multiple time steps, which word in the vocabulary has a highest probability of occurrence according to the set of output values for the time step.

The transcription for the utterance is provided (210). The transcription may be provided to the client device over a computer network in response to receiving the audio data from the client device.

The process of determining the transcription based on the output of the recurrent neural network comprises determining the transcription without using a beam search technique. The output from the neural network may be sent to the word sequencer without any decoding step or language model.

The present disclosure describes a competitive, greatly simplified, large vocabulary continuous speech recognition system with whole words as acoustic units. In one example, an output vocabulary of 80,000 words was modeled directly with deep bi-directional CTC LSTMs. The model was trained on 125,000 hours of semi-supervised acoustic training data, which alleviated the data sparsity problem for word models. The CTC word models work very well as an end-to-end model without the use of traditional context-dependent sub-word phone units that require a pronunciation lexicon, or any language model removing the need to decode. In fact, the CTC word models perform better than a strong, more complex, state-of-the-art baseline with sub-word units. These techniques can be used to provide end-to-end speech recognition with neural networks.

For automatic speech recognition, the general goal is to minimize the word error rate. Words can be used as units for acoustic modeling and estimate word probabilities. Recently, the amount of user-uploaded captions for public YouTube videos has grown dramatically. Using powerful neural network models with large amounts of training data can allow systems to directly model words and greatly simplify an automatic speech recognition system.

A NSR can be a single neural network model capable of accurate speech recognition with no search or decoding involved. The NSR model has a deep LSTM RNN architecture built by stacking multiple LSTM layers. The architecture can use a bidirectional architecture. In many instances, bidirectional RNN models have better accuracy than unidirectional models. However, maximum accuracy is typically achieved when the system can operate on significant sections of an utterance, e.g., 5 seconds, 10 seconds, 30 seconds, or even the entire utterance. As a result, using a bidirectional neural network may introduce significant latency between audio capture and a recognition result. Nevertheless, the high accuracy of a bidirectional neural network structure may be beneficial in various application, especially when latency is not critical, such as a useful application includes offline speech recognition. In the bidirectional network, two LSTM layers can be used at each depth—one operating in the forward direction and another operating in the backward direction in time over the input sequence. Both these layers are connected to both previous forward and backward layers.

The neural speech recognizer model may have a final softmax layer predicting word posteriors with the number of outputs equaling the vocabulary size. A large amount of acoustic training data may be used to alleviate problems due to data sparsity. The vocabulary obtained from the training data transcripts is mapped to the spoken forms to reduce the data sparsity further and limit label ambiguity. For written-to-spoken domain mapping a FST verbalization model may be used. For example, “104” is converted to “one hundred four” and “one oh four”. Given all possible verbalizations for an entity, the one that aligns best with acoustic training data may be chosen.

The NSR model is essentially an all-neural network speech recognizer that does not require any beam search type of decoding. The network may take as input mel-spaced log filterbank features. The word posterior probabilities output from the model can be simply used to get the recognized word sequence. Since this word sequence is in spoken domain for the spoken vocabulary model, to get the written forms, a simple lattice can be created by enumerating the alternate words and blank label at each time step, and by rescoring this lattice with a written-domain word language model (LM) by FST composition after composing it with the verbalizer FST. For the written vocabulary model, the lattice is directly composed with the language model to assess the importance of language model rescoring for accuracy.

The word sequence obtained as output from the process is in the spoken domain. In some implementations, a written form of the transcription may be generated. In some aspects, a lattice is created by enumerating the alternate words and blank label at each time step. The lattice is re-scored with a written-domain word language model by FST (finite state transducers) composition. The process may involve training a language model in the written language domain, and integrating verbal expansions of vocabulary items as a finite-state model into the decoding graph construction. In some implementations, the transcription may be provided as a caption for the audio data.

In some implementations, the audio data may include audio data from an Internet resource. Further, the transcription may be provided as a caption for the audio data from the Internet resource. For example, the neural speech recognizer may be used to generate captions for Internet videos, such as those hosted by YouTube® or other services.

The recurrent neural network may be trained using asynchronous stochastic gradient descent (ASGD) with a large number of machines. The word acoustic models performed better when initialized using the parameters from hidden states of phone models. For example, the output layer weights may be randomly initialized and the weights in the initial networks may be randomly initialized with a uniform (−0.04, 0.04) distribution. For training stability, the activations of memory cells may be clipped to [−50, 50], and the gradients to [−1, 1] range. An optimized native TensorFlow CPU kernel (multi_lstm_op) may be implemented for multi-layer LSTM RNN forward pass and gradient calculations. The multi_lstm_op may allow the parallelized computations across LSTM layers using pipelining and the resulting speed-up may decreases the parameter staleness in asynchronous updates and improves accuracy.

The models were evaluated on videos sampled from Google Preferred channels on YouTube. The test set is comprised of 296 videos from 13 categories, with each video averaging 5 minutes in length. The total test set duration is roughly 25 hours and 250,000 words. As the bulk of the training data is not supervised, an important question is how valuable this type of the data is for training acoustic models. The language model may be kept constant and a 5-gram model may be used with 30M N-grams over a vocabulary of 500,000 words.

Training large, accurate neural network models for speech recognition requires abundant data. Training data for training the neural network model may be obtained by using the method described generally in H. Liao, E. McDermott, and A. Senior, “Large scale deep neural network acoustic modeling with semi-supervised training data for YouTube video transcription,” in Proceedings of the Automatic Speech Recognition and Understanding Workshop, ASRU 2013, which is incorporated herein by reference. The method may be scaled up to obtain a larger training set. For example, a training set of over 125,000 hours may be built using this method.

This “islands of confidence” filtering, may allow the use of user-uploaded captions for labels, by selecting only audio segments in a video where the user uploaded caption matches the transcript produced by an ASR system constrained to be more likely to produce N-grams found in the uploaded caption. Of the approximately 500,000 hours of video available with English captions, a quarter remained after filtering.

In one aspect, the recurrent neural network may be trained with the CTC loss criterion, which is a sequence alignment/labeling technique with a softmax output layer that has an additional unit for the blank label used to represent outputting no label at a given time. CTC is described generally in A. Graves, S. Fernandez, F. Gomez, and J. Schmidhuber, “Connectionist Temporal Classification: Labelling Unsegmented Sequence Data with Recurrent Neural Networks,” in Proceedings of the International Conference on Machine Learning, ICML 2006, Pittsburgh, USA, 2006, which is incorporated herein by reference. The output label probabilities from the network define a probability distribution over all possible labels of input sequences including the blank labels. The network may be trained to optimize the total probability of correct labeling for training data as estimated using the network outputs and forward-backward algorithm. The correct labelings for an input sequence are defined as the set of all possible labelings of the input with the target labels in the correct sequence order possibly with repetitions and with blank labels permitted between labels. The model may have a final softmax predicting word posteriors with the number of outputs equaling the vocabulary size. Modeling words directly can be problematic due to data sparsity, but a large amount of acoustic training data may be used to alleviate it. The system can be used with both written and spoken vocabulary. The vocabulary obtained from the training data transcripts may be mapped to the spoken forms to reduce the data sparsity further and limit label ambiguity for the spoken vocabulary experiments. The CTC loss can be efficiently and easily computed using finite state transducers (FSTs) as described by the equation (1) below:

$${ℒ}_{CTC} = - {\sum }_{( x , l )} ln p ( {z}^{l} \vert x ) = - {\sum }_{( x , l )} ℒ ( x , {z}^{l} ) \qquad ( 1 )$$

where x is the input sequence of acoustic frames, l is the input label sequence (e.g. a sequence of words for the NSR model), z^{l} is the lattice encoding all possible alignments of x with l which allows label repetitions possibly interleaved with blank labels. The probability for correct labelings p(z^{l}|x) can be computed using the forward-backward algorithm. The gradient of the loss function with respect to input activations aₗ^{t} of the softmax output layer for a training example can be computed by equation (2) below:

$$\frac{\partial ℒ ( x , {z}^{l} )}{\partial {a}_{l}^{t}} = {y}_{l}^{t} - \frac{1}{p ( {z}^{l} \vert x )} {\sum }_{u ∈ ( u : {z}_{u}^{l} = l \}} {α}_{x , {z}^{l}} ( t , u ) {β}_{x , z} ( t , u ) \qquad ( 2 )$$

where yₗ^{t} is the softmax activation for a label l at time step t, and u represents the lattice states aligned with label l at time t, a_{x,zl} (t, u) is the forward variable representing the summed probability of all paths in the lattice z^{l} starting in the initial state at time 0 and ending in state u at time t, β(t, u) is the backward variable starting in state u of the lattice at time t and going to a final state.

In one example, an initial acoustic model was trained on 650 hours of supervised training data that comes from YouTube, Google Videos, and Broadcast News. The acoustic model is a 3-state HMM with 6400 CD triphone states. This system gave a 29.0% word error rate on the Google Preferred test set as shown in table 1. By training with a sequence-level state-MBR criterion and using a two-pass adapted decoding setup, this was improved to 24.0% with a 650 hour training set. By adding more semi-supervised training data: at 5000 hours, the error rate was reduced to 21.2% for the same model size. With more data available, and models that can capture longer temporal context, the results for single-state CD phone units can be shown, which give a 4% relative improvement over the 3-state triphone models. This type of model improves with the amount of training data and cross-entropy (CE) or CTC training criteria can be used.

In the example, the entire acoustic training corpus had 1.2 billion words with a vocabulary of 1.7 million words. For the neural speech recognizer, experiments were carried out with both spoken and written output vocabularies with the CTC loss. For the spoken vocabulary, words that occurred more than 100 times may be modelled. Doing so in this example results in a vocabulary of 82473 words and an OOV (out-of-vocabulary) rate of 0.63%. For the written vocabulary, words seen more than 80 times may be chosen, resulting in 97827 words and an OOV rate of 0.7%. For comparison, the full test vocabulary of the baseline has 500,000 words and an OOV rate of 0.24%. The impact of the reduced vocabulary was evaluated with CD phone models and an increase of 0.5% in WER (Word Error Rate) was observed. Models were trained with 5×600 and 7×1000 bidirectional LSTM layers. As the output layer for the word models is substantially larger, the total number of parameters for the word models is larger than for the CD phone models for the same number and size of LSTM layers. The number of parameters for CD phone models may be increased, but that does not yield a reduction in error rate. Deep decision trees tend to work mostly in scenarios when the phonetic contexts are well-matched in training and test data. As the difference in performance between CTC and CE phone models is often not extreme, a similar comparison may be run for word models. The models were trained on 50,000 hours of data: with CE training, the model performed poorly with an error rate of 23.1%, while training with CTC loss performed substantially better at 18.7%. Predicting longer units on a frame by frame basis with CE makes the prediction task substantially harder. The word models outperform the CD phone models even with the handicap of a higher OOV rate for the word models.

The CTC word model can be used directly without any decoding or language model and the recognition output becomes the output from the CTC layer, essentially making the CTC word model an end-to-end all-neural speech recognition model. The entire speech recognizer becomes a single neural network. Plot 126 shows the word posterior probabilities as predicted by the model for a music video. Even though it has not been trained on music videos, the model is quite robust and accurate in transcribing the songs. Without any use of a language model and decoding, the CTC spoken word model has an error rate of 14.8% and the CTC written word model has 13.9% WER. The written word model is better than the conventional CD phone model, which has 14.2% WER obtained with decoding with a language model. This shows that bi-directional LSTM CTC word models are capable of accurate speech recognition with no language model or decoding involved. The language model may be pruned heavily to a de-weighted uni-gram model and used with the CTC CD phone models. As expected, the error rate increases drastically, from 14.2% to 21%, showing that the language model is important for conventional models but less important for whole word CTC models. For the spoken word model, the WER improves to 14.8% when the word lattices obtained from the model are rescored with a language model. The improvements are mostly due to conversion of spoken word forms to written forms (such as numeric entities) since the WER scoring is done in the written domain. The WER of written word model improves only by 0.5% to 13.4% when the word lattices are rescored with the LM, showing the relatively small impact of the LM in the accuracy of the system.

The error rate calculation disadvantages the CTC spoken word model as the references are in written domain, but the output of the model is in spoken domain, creating artificial errors like “three” vs “3”. This is not the case for the conventional CD phone baseline and the CTC written word model, as words are there modeled in the written domain. To evaluate the error rate in the spoken domain, the test data may be automatically converted by force aligning the utterances with a graph built as C*L*project(V*T), where C is the context transducer, L the lexicon transducer, V the spoken-to-written transducer, and T the written transcript. Project maps the input symbols to the output symbols, thereby the output symbols of the entire graph will be in the spoken domain. The same approach may be used to convert the written language model G to a spoken form by calculating project(V*G) and using the spoken LM to build the decoding graph. The word models without the use of any language model or decoding performs at 12.0% WER, slightly better than the CD phone model that uses an LVCSR decoder and incorporates a 30 m 5-gram language model. The effect of the language model can be separated from the spoken-to-written text normalization. Adding the language model for the CTC spoken word model improves the error rate from 12.0% to 11.6%, showing the CTC spoken word models perform very well even without the language model.

In general, the Neural Speech Recognizer approach discussed above can provide an end-to-end large vocabulary continuous speech recognizer that forgoes the use of a pronunciation lexicon and a decoder. Mining 125,000 hours of training data using public captions allows the training of a large and powerful bi-directional LSTM model of speech with a CTC loss that directly predicts words. Unlike many end-to-end systems that compromise accuracy for system simplicity, the NSR system performs better than a well-trained, conventional context-dependent phone-based system achieving a 13.5% word error rate on a difficult YouTube video transcription task.

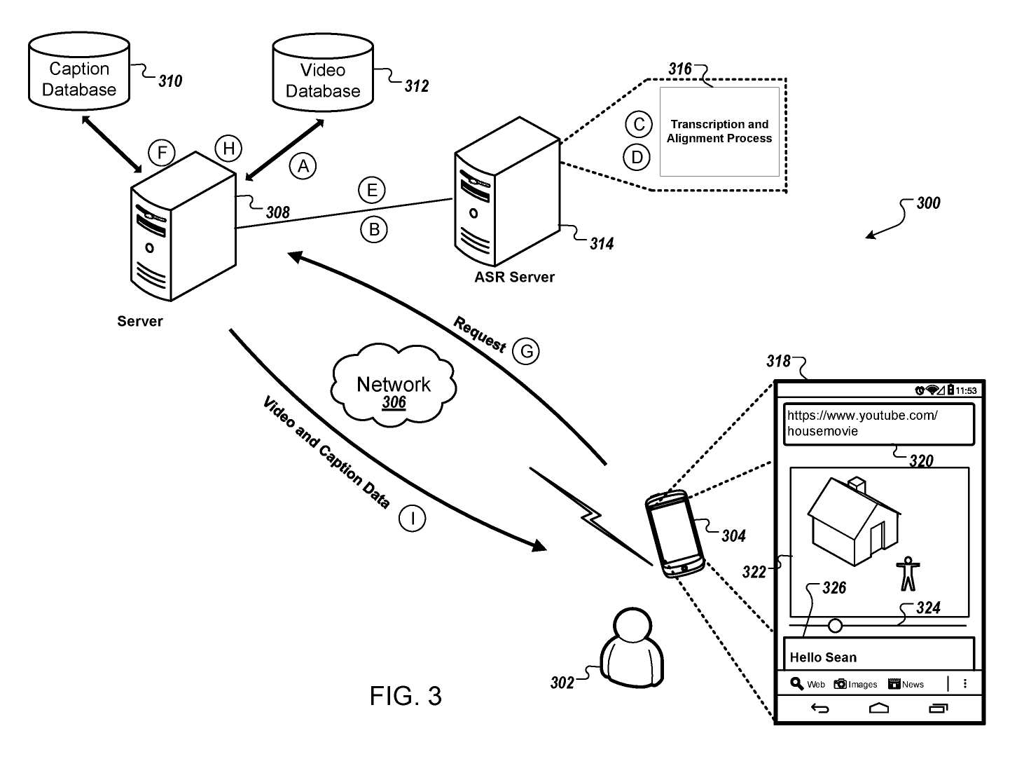

FIG. 3 is a block diagram that illustrates an example of a system 300 for acoustic-to-word processing using recurrent neural networks. The system 300 includes a client 302, a client device 304, a server 308, a caption database 310, a video database 312, and an ASR server 314. In system 300, the server 308 provides acoustic information from a video retrieved from the video database 312 to the ASR server 314 for processing using a neural network. Using output from the neural network, the ASR server 314 identifies a transcription for the acoustic information. The ASR server 314 provides the transcription as a caption for the acoustic information from the server 308, and transmits the transcription to the server 308. In some implementations, the analysis and transcription may be performed on only one server, such as server 308.

The server 308 stores the transcription for the video in the caption database 310. When a client device 304 requests the video, the server 308 retrieves the video from the video database 312 and retrieves the corresponding transcription from the caption database 310, and provides them to the client device 304.

In some implementations, the system 300 generates a transcription in the manner described with respect to FIG. 1. For example, the ASR server 314 receives acoustic data from a server 308 and generates acoustic features, such as acoustic features 114, of the acoustic data. The ASR server 314 inputs the acoustic features 114 to a recurrent neural network, such as the recurrent neural network 116, for processing. The recurrent neural network 116 processes the acoustic features 114 to output a set of scores, such as scores indicating word occurrence probabilities.

As mentioned above, the set of probabilities output by the neural network and transcribing process, such as a set of posterior probabilities, can indicate a likelihood of word occurrences in a vocabulary. These probabilities are used to determine a transcription, such as transcription 122, for a portion of the acoustic features 114. The ASR server 314 matches the transcription 122 to the corresponding portions of the acoustic data 114 and transmits information indicating the correspondence to server 308. For example, the server 314 aligns the transcription 122 to the video associated with the acoustic data 114 by indicating start and/or stop times for different words or phrases in the transcription, so that the display of the transcription can be aligned with the corresponding utterances in the video. The server 308 stores the transcription 122 in the caption database 310, along with alignment data showing how the transcription aligns in time with the video in video database 312.

In the system 300, the client device 304 can be, for example, a desktop computer, laptop computer, a tablet computer, a wearable computer, a cellular phone, a smart phone, a music player, an e-book reader, a navigation system, or any other appropriate computing device. The functions performed by the server 308 and the ASR server 314 can be performed by individual computer systems or can be distributed across multiple computer systems. The network 130 can be wired or wireless or a combination of both and can include the Internet.

In the illustrated example of system 300, the user 302 of the client device 304 may search for a video on the Internet, such as a video on YouTube®, that includes speech. For example, the user 302 enters in a URL 320 such as “https://www.example.com/movie” to the client device 304. The client device 304 transmits the video request to the server 308 over the network 306.

The server 308 receives the request from client device 304. In response, the server 308 determines if a transcription 122 for the video exists in the caption database 310. If a transcription 122 already exists, the server 308 transmits the requested video and aligned transcription 122 to the client device 304 over the network 306. However, if a transcription 122 is not available for the associated video, the server 308 may transmit acoustic features or other audio data of the requested video to the ASR server 314 for transcription. Following processing by the ASR server 314, the server 308 receives the transcription 122 and alignment data from the ASR server 314. The server 308 can then serve the requested video, with a transcription provided as caption data, to the client device 304 over the network 306.

The client device 304 displays the received video and aligned transcription 122 on the display 318. As shown in the illustrated example, the video 322 shows an individual speaking in front of a house. The elapsed time progress bar 324 has moved a distance from the left most point, displaying video associated with that particular point in time. In addition, a transcription 122 “Hello Sean” appears in the display box 326 on the client device 304. In some implementations, the display box 326 may be configured anywhere on display 318. For example, the transcription 122 may be embedded in the video 322 and no display box 326 will be necessary, increasing the size of video 322 to fill the display 318.

In stage (A), the server 308 retrieves video from the video database 312. For example, the server 308 may retrieve video corresponding to the URL 320.

In stage (B), the server 308 determines the audio data from the video and transmits the audio data to the ASR server 314. The audio data from the video includes utterance of a speaker.

In stage (C), ASR server 314 performs speech recognition on the audio data to generate a transcription for speech in the video. The server 314 uses a neural network model as discussed above. The ASR server 314 performs feature extraction on the audio data. The ASR server 314 extracts acoustic feature vectors from the audio data to provide to the neural network model. In this instance, as described with respect to FIGS. 1 and 2, the neural network model can be a recurrent neural network trained to label acoustic data using connectionist temporal classification (CTC). The recurrent neural network may be a deep LSTM recurrent neural network architecture built by stacking multiple LSTM layers 126ₐ-126ₙ. The neural network may be a bidirectional neural network that includes a plurality of forward-propagating LSTM layers and a plurality of backward-propagating LSTM layers, with two LSTM layers at each depth—one operating in the forward and another operating in the backward direction in time over the input sequence.

In some implementations, the trained recurrent neural network provides outputs indicating whole word probabilities. A set of output values from the recurrent neural network for each of multiple time steps may be received, wherein each set of output values includes a probability of occurrence for each of multiple words in a vocabulary. The vocabulary may comprise a predetermined set of words. The step of receiving the output of the recurrent neural network may comprise receiving a set of probability scores that includes a probability score for each word in the predetermined set of words for each of multiple time steps. Each output vector produced by the CTC output layer 128 may include a score for each respective word from a set of words and also a score for a “blank” symbol. The score for a particular word represents a likelihood that the particular word has occurred in the sequence of audio data inputs provided to the neural network 116. The blank symbol is a placeholder indicating that the neural network 116 does not indicate that any additional word has occurred in the sequence. Thus, the score for the blank symbol represents a likelihood or confidence that an additional word should not yet be placed in sequence.

In some implementations, the output of the trained recurrent neural network may be provided to a word sequencer 120. The word sequencer 120 determines a transcription for the utterance. The word sequencer 120 determines the transcription for the utterance based on a determination, for each of multiple time steps, which word in the vocabulary has a highest probability of occurrence according to the set of output values for the time step.

In stage (D), the ASR server 314 aligns the output transcription 122 with the acoustic features. For instance, the ASR server 314 stores data that associates the output transcription 122 with the video data. For example, the transcription can be stored in the caption database 310 and designated as the transcription for a particular video. In addition, the text of the transcription can be marked with metadata indicating the times when different words of the captions should be shown during display of the video.

In stage (E), the ASR server 314 transmits the transcription 122 with the acoustic features to server 308. For example, the ASR server 314 transmits the package of the transcription 122 using a communication protocol such as TCP or UDP.

In stage (F), the server 308 aligns the transcription 122 with acoustic features and the video. For example, the server 308 synchronizes the transcription 122 with the acoustic features and the video. The server 308 stores the aligned and synchronized transcription 122 in the caption database 310 and the video in the video database 312.

In stage (G), the server 308 receives a request for a video from client device 304. For example, the request may be a search query including one or more terms, a request for a resource such as a web page corresponding to a certain URL, or another request.

In stage (H), the server 308 retrieves the video and associated caption data from the video database 312 and the caption database 310, respectively. The server 308 retrieves the video and associated caption data corresponding to the request for the video from the client device 304. For example, the retrieved video may be video 322 shown in the example of FIG. 1.

In stage (I), the server 308 transmits the video and associated transcription 122 to the client device 304 per the request of user 302.

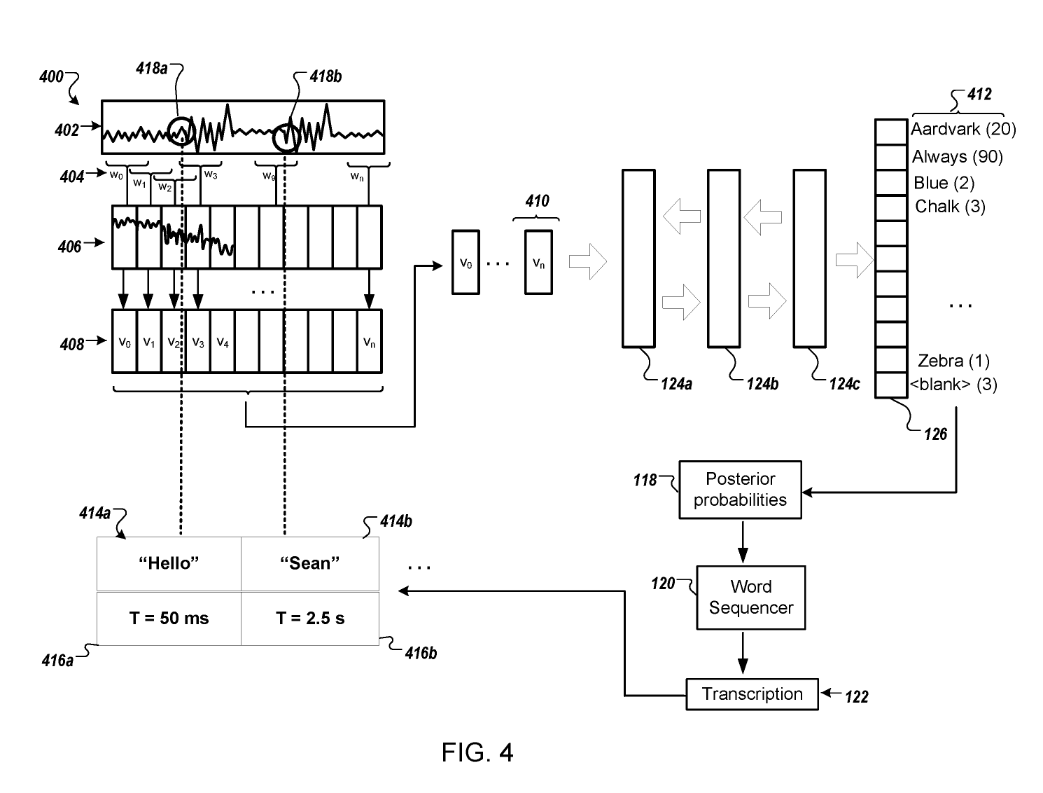

FIG. 4 is a diagram that illustrates an example of processing for speech recognition using neural networks. The operations discussed are described as being performed by the ASR server 314, but may be performed by other systems, including combinations of multiple computing systems.

The ASR server 314 receives an audio signal 402 that includes speech to be recognized. The ASR server 314 performs feature extraction on the audio signal 402. For example, the ASR server 314 analyzes different segments or analysis windows 404 of the audio signal 402. These windows 404, labeled w₀ . . . wₙ, may overlap. For example, as shown in FIG. 4, each window 404 may include 25 ms of the audio signal 402, and a new window 404 may begin every 10 ms. For example, the window 404 labeled w₀ may represent a portion of audio signal 404 from a start time of 0 ms to an end time of 25 ms. The next window 404 w₁, may represent a portion of audio signal 404 from a start time of 10 ms to an end time of 35 ms. In this manner, each window 404 includes 15 ms of the audio signal 404 that is included in the previous window 404.

Also mentioned above, the frames may be analyzed to determine feature vectors for each of the frames. For example, the ASR server 314 performs a Fast Fourier Transform (FFT) on the audio in each window 404. The time frequency representations 406 displays the results of the FFT performed on each window 404. The ASR server 314 extracts acoustic features from each time frequency representation 406 and stores the results in acoustic feature vector 408. The acoustic features may be determined as mel-frequency cepstral coefficients (MFCCs), using a perceptual linear prediction (PLP) transform, or using other techniques. In some implementations, the logarithm of the energy in each of various bands of the FFT may be used to determine acoustic features.

The acoustic feature vectors 408, labeled v₁ . . . vₙ, include values corresponding to each of multiple dimensions. As mentioned above, these values may indicate acoustic features of multiple dimensions of the utterance at a particular point in time. For example, each acoustic feature vector 408 may include a value for a PLP feature, a value for a first order temporal difference, and a value for a second order temporal difference, for each of 13 dimensions, for a total of 39 dimensions per acoustic feature vector 408. Each acoustic feature vector 408 represents characteristics of the portion of the audio signal 402 within its corresponding window 404.

The ASR server 314 uses a neural network, such as recurrent neural network 316, that can serve as an acoustic model and indicate likelihoods that acoustic feature vectors 408 represent different word units. The recurrent neural network 316 includes a number of hidden layers 124a-124c, and a CTC output layer 126. As mentioned above, the recurrent neural network 116 includes a plurality of forward-propagating long short-term memory layers and a plurality of backward-propagating long short-term memory layers. The hidden layers 124a-124c represent the bi-directional LSTM layers.

At the CTC output layer 126, the recurrent neural network 116 indicates likelihoods that various words have occurred in the audio data 402. The CTC output layer 126 can provide a probability score for each word in the predetermined set of words that the model is trained to detect, as well as a probability score for the blank label. For example, the predetermined set of words may be a predefined vocabulary, which includes hundreds, thousands, or tens of thousands of words.

The CTC output layer 126 provides predictions or probabilities of word occurrences. For example, for a first word, “aardvark”, the CTC output layer 126 can provide a value that indicates a probability of 0.1 that the word “aardvark” has occurred. The CTC output layer 126 provides a value that indicates a probability of 0.2 for a second word, “always”, from the predetermined set of words. The CTC output layer 126 similarly provides a probability score for each of the other labels, each of which represent different words in the predetermined set of words or the blank label.

The ASR server 314 provides one acoustic feature vector 410 from the set of acoustic feature vectors 408 at a time to the recurrent neural network 116. In some implementations, the ASR server 314 also provides one acoustic feature vector 410 from the set of acoustic feature vectors 408 at a time in a reversed order (e.g., starting at the end of the utterance and moving toward the beginning).

The CTC output layer 128 produces outputs 118, e.g., outputs that provide a probability distribution over the set of potential output labels (e.g., the set that includes the predetermined word vocabulary and the blank label). The word sequencer 120 picks the highest likelihood outputs 118 to identify a transcription 122 for the current portion of an utterance being assessed. This can be done without beam search, for example, by simply selecting the label with the highest probability at each neural network output vector. The ASR server 314 aligns the transcription 122 with the audio signal 402. For example, the ASR server 314 outputs a transcription 122, which reads “Hello” 414a and “Sean” 414b. From the correspondence between the output labels for these words and the inputs representing the audio data 402, the ASR server 314 aligns the identified utterance “Hello” 414a with the start time of window w₂, t=50 ms 416a, because the identified utterance 414a is initially spoken in the middle of window w₂. Additionally, the ASR server 314 aligns the identified utterance “Sean” 414b with the start time of window w₉, t=2.5 s 416b, because the identified utterance 416b is initially spoken in the middle of window w₉. This ASR server 314 continues the process of aligning identifying utterances with window wₙ start times until the entire audio signal 402 is processed. The ASR server 314 transmits the identified utterances 414a and 412b and associated start times 416a and 416b to server 308.

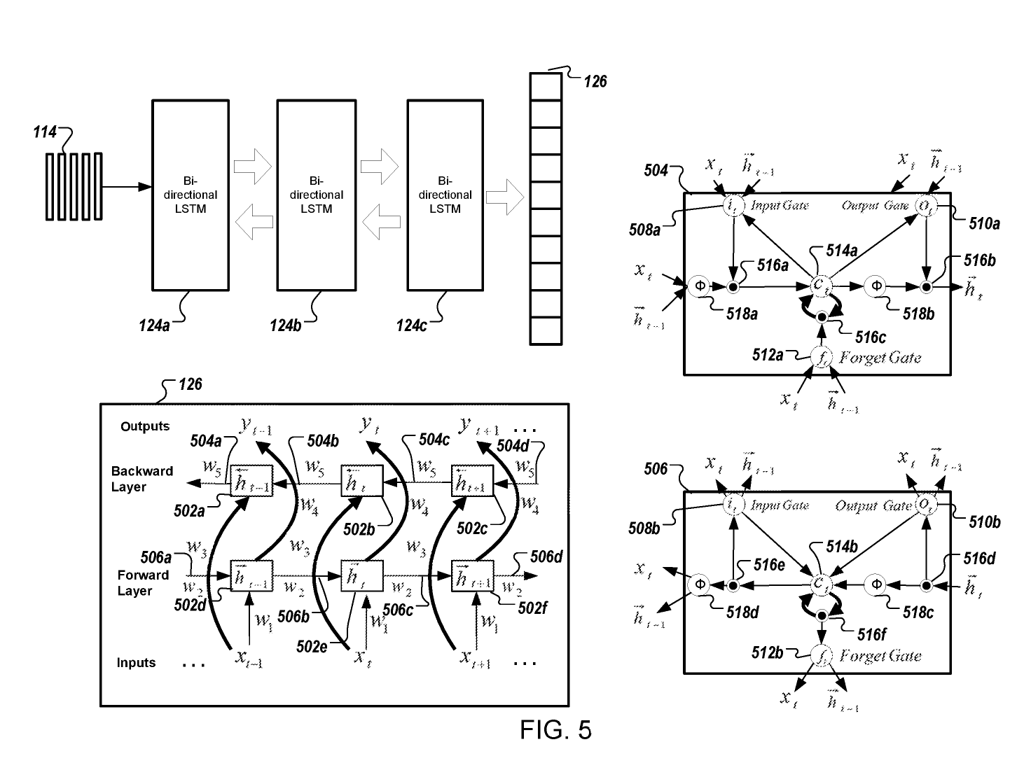

FIG. 5 is a diagram that illustrates examples of structures in the recurrent neural network 116.

The recurrent neural network 116 illustrated in FIG. 5 includes a stack of multiple LSTM layers 124ₐ-124ₙ. As mentioned above, the recurrent neural network 116 may be a bidirectional neural network that includes a plurality of forward-propagating LSTM layers and a plurality of backward-propagating LSTM, with two LSTM layers at each depth. For example, LSTM layer 124 includes sequential inputs at particular points in time (e.g., xₜ₋₁, xₜ, xₜ₊₁), a forward layer, a backward layer, and sequential outputs at the particular points in time (e.g., yₜ₋₁, yₜ, yₜ₊₁). In the forward layer, memory output blocks \vec{h}ₜ 502d-502f store an output hidden sequence in a forward direction. Simultaneously, memory output blocks [symbol] ₜ 502a-502c store an output hidden sequence in a backwards direction. Weight matrix wₙ, in between each of the memory output blocks [symbol] ₜ 502a-502f, direct the operation of each gate in the memory cell 504. Specifically, the weight matrix wₙ is a set of filters to determine how much importance to accord the present input state and the past hidden state of the memory cell 504. Additionally, the recurrent neural network 116 may update the weight matrix wₙ during backpropagation training to minimize error recognition in each LSTM layer 126.

Each LSTM layer 124 includes one or more memory cells 506a-506d for the forward layer and one or more memory cells 504a-504d for the backwards layer. The forward memory cells 506a-506d exist between each memory output blocks \vec{h}ₜ 502d-502f in the forward layer. Additionally, the backward memory cells 504a-504d exist between each memory output blocks \vec{h}ₜ 502a-502c in the backward layer. Each memory cell 504 and 506 includes an input gate 508, an output gate 510, a forget gate 512, a cell state vector gate 514, a dot product gate 516, and an activation function gate 518a-518d. Memory cells 504 and 506 contain the same internal components; however, the direction of data flow between gates changes based on the respective layer. For example, in the forward layer, the data flows from dot product gate 516a to cell state vector gate 514a. Alternatively, in the backward layer, the data flows from the cell state vector gate 514b to dot product gate 516e.

In the forward memory cell 504, the input gate 506 controls the amount at which a new value flows into the memory cell 504. The output gate 510 controls the extent to which the value stored in the memory cell 504 is used to complete the output of the activation block 514. The forget gate 512 determines whether the current contents of memory cell 504 will be erased. In some implementations, the memory cell 504 combines the forget gate 512 and the input gate 508 into a single gate. The reason is because the forget gate 512 will forget an old value when a new value, worth remembering becomes, available in the input gate 508. The cell state vector gate 514 is a current state of the memory cell. For example, the cell state vector gate 513 may forget its state, or not; be written to, or not; and be read from, or not, at each time step as the sequential data is passed through the memory cell 506. The dot product gate 506 is an element-wise multiplication gate. For example, the dot product gate 506 may be a Hadamard product function. The activation function gate 518 is a function that defines an output given an input or a set of inputs. For example, the activation function gate 518 may be a sigmoid function, a hyperbolic tangent function, or a combination of both, to name a few examples. For example, the activation function gate 518a receives input from xₜ and \vec{h}ₜ₋₁, applies a sigmoid function to the combination of the two inputs, sums the output, and passes the output to the dot product gate 518a. Alternatively, the activation function gate 518a may perform other mathematical functions on the output of the sigmoid function, such as multiplication, before passing the output to the dot product gate 518a.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them. The computer storage medium is not, however, a propagated signal.

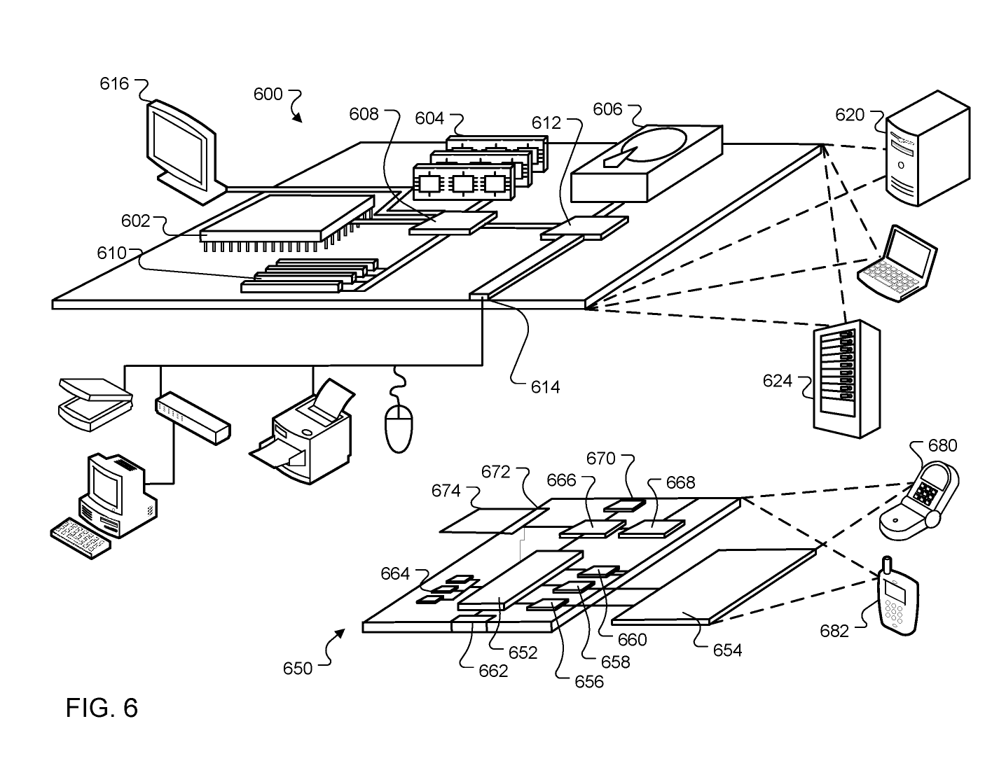

FIG. 6 shows an example of a computing device 600 and a mobile computing device 650 that can be used to implement the techniques described here. The computing device 600 is intended to represent various forms of digital computers, such as laptops, desktops, workstations, personal digital assistants, servers, blade servers, mainframes, and other appropriate computers. The mobile computing device 650 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 600 includes a processor 602, a memory 604, a storage device 606, a high-speed interface 608 connecting to the memory 604 and multiple high-speed expansion ports 610, and a low-speed interface 612 connecting to a low-speed expansion port 614 and the storage device 606. Each of the processor 602, the memory 604, the storage device 606, the high-speed interface 608, the high-speed expansion ports 610, and the low-speed interface 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as a display 616 coupled to the high-speed interface 608. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 604 stores information within the computing device 600. In some implementations, the memory 604 is a volatile memory unit or units. In some implementations, the memory 604 is a non-volatile memory unit or units. The memory 604 may also be another form of computer-readable medium, such as a magnetic or optical disk.

The storage device 606 is capable of providing mass storage for the computing device 600. In some implementations, the storage device 606 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 602), perform one or more methods, such as those described above. The instructions can also be stored by one or more storage devices such as computer- or machine-readable mediums (for example, the memory 604, the storage device 606, or memory on the processor 602).

The high-speed interface 608 manages bandwidth-intensive operations for the computing device 600, while the low-speed interface 612 manages lower bandwidth-intensive operations. Such allocation of functions is an example only. In some implementations, the high-speed interface 608 is coupled to the memory 604, the display 616 (e.g., through a graphics processor or accelerator), and to the high-speed expansion ports 610, which may accept various expansion cards (not shown). In the implementation, the low-speed interface 612 is coupled to the storage device 606 and the low-speed expansion port 614. The low-speed expansion port 614, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. In addition, it may be implemented in a personal computer such as a laptop computer 622. It may also be implemented as part of a rack server system 624. Alternatively, components from the computing device 600 may be combined with other components in a mobile device (not shown), such as a mobile computing device 650. Each of such devices may contain one or more of the computing device 600 and the mobile computing device 650, and an entire system may be made up of multiple computing devices communicating with each other.

The mobile computing device 650 includes a processor 652, a memory 664, an input/output device such as a display 654, a communication interface 666, and a transceiver 668, among other components. The mobile computing device 650 may also be provided with a storage device, such as a micro-drive or other device, to provide additional storage. Each of the processor 652, the memory 664, the display 654, the communication interface 666, and the transceiver 668, are interconnected using various buses, and several of the components may be mounted on a common motherboard or in other manners as appropriate.

The processor 652 can execute instructions within the mobile computing device 650, including instructions stored in the memory 664. The processor 652 may be implemented as a chipset of chips that include separate and multiple analog and digital processors. The processor 652 may provide, for example, for coordination of the other components of the mobile computing device 650, such as control of user interfaces, applications run by the mobile computing device 650, and wireless communication by the mobile computing device 650.

The processor 652 may communicate with a user through a control interface 658 and a display interface 656 coupled to the display 654. The display 654 may be, for example, a TFT (Thin-Film-Transistor Liquid Crystal Display) display or an OLED (Organic Light Emitting Diode) display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may provide communication with the processor 652, so as to enable near area communication of the mobile computing device 650 with other devices. The external interface 662 may provide, for example, for wired communication in some implementations, or for wireless communication in other implementations, and multiple interfaces may also be used.

The memory 664 stores information within the mobile computing device 650. The memory 664 can be implemented as one or more of a computer-readable medium or media, a volatile memory unit or units, or a non-volatile memory unit or units. An expansion memory 674 may also be provided and connected to the mobile computing device 650 through an expansion interface 672, which may include, for example, a SIMM (Single In Line Memory Module) card interface. The expansion memory 674 may provide extra storage space for the mobile computing device 650, or may also store applications or other information for the mobile computing device 650. Specifically, the expansion memory 674 may include instructions to carry out or supplement the processes described above, and may include secure information also. Thus, for example, the expansion memory 674 may be provided as a security module for the mobile computing device 650, and may be programmed with instructions that permit secure use of the mobile computing device 650. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier, such that the instructions, when executed by one or more processing devices (for example, processor 652), perform one or more methods, such as those described above. The instructions can also be stored by one or more storage devices, such as one or more computer- or machine-readable mediums (for example, the memory 664, the expansion memory 674, or memory on the processor 652). In some implementations, the instructions can be received in a propagated signal, for example, over the transceiver 668 or the external interface 662.

The mobile computing device 650 may communicate wirelessly through the communication interface 666, which may include digital signal processing circuitry where necessary. The communication interface 666 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 668 using a radio-frequency. In addition, short-range communication may occur, such as using a Bluetooth, WiFi, or other such transceiver (not shown). In addition, a GPS (Global Positioning System) receiver module 670 may provide additional navigation- and location-related wireless data to the mobile computing device 650, which may be used as appropriate by applications running on the mobile computing device 650.

The mobile computing device 650 may also communicate audibly using an audio codec 660, which may receive spoken information from a user and convert it to usable digital information. The audio codec 660 may likewise generate audible sound for a user, such as through a speaker, e.g., in a handset of the mobile computing device 650. Such sound may include sound from voice telephone calls, may include recorded sound (e.g., voice messages, music files, etc.) and may also include sound generated by applications operating on the mobile computing device 650.

The mobile computing device 650 may be implemented in a number of different forms, as shown in the figure. For example, it may be implemented as a cellular telephone 680. It may also be implemented as part of a smart-phone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. For example, while a client application is described as accessing the delegate(s), in other implementations the delegate(s) may be employed by other applications implemented by one or more processors, such as an application executing on one or more servers. In addition, the logic flows depicted in the figures do not require the particular order shown, or sequential order, to achieve desirable results. In addition, other actions may be provided, or actions may be eliminated, from the described flows, and other components may be added to, or removed from, the described systems. Accordingly, other implementations are within the scope of the following claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method performed by one or more computers of an automated speech recognition system, the method comprising:
receiving, by the one or more computers, audio data representing an utterance of a speaker;
providing, by the one or more computers, acoustic features of the audio data to a recurrent neural network trained using connectionist temporal classification to estimate likelihoods of occurrence of whole words based on acoustic feature input;
receiving, by the one or more computers, output of the recurrent neural network generated in response to the acoustic features, the output indicating a likelihood of occurrence for each of multiple different words in a vocabulary;
determining, by the one or more computers, a transcription for the utterance based on the output of the recurrent neural network; and
providing, by the one or more computers, the transcription as output of the automated speech recognition system.

2. The method of claim 1, wherein the recurrent neural network is trained as a speaker-independent recognizer for continuous speech.

3. The method of claim 1, wherein the neural network is a bidirectional neural network that includes a plurality of forward-propagating long short-term memory layers, a plurality of backward-propagating long short-term memory layers, and a connectionist temporal classification output layer for classification decisions.

4. The method of claim 1, further comprising feature vectors that each include a set of mel-frequency coefficients for a different segment of the utterance;
wherein providing the acoustic features of the audio data to the recurrent neural network comprises:
providing the feature vectors as input to the recurrent neural network in a first sequence; and
providing the feature vectors as input to the recurrent neural network in a second sequence having a reversed order of the first sequence.

5. The method of claim 1, wherein the vocabulary comprises a predetermined set of words; and
wherein receiving the output of the recurrent neural network comprises:
for each of multiple time steps, receiving a set of probability scores that includes a probability score for each word in the predetermined set of words.

6. The method of claim 5, wherein the vocabulary comprises at least 1,000 words.

7. The method of claim 5, wherein the vocabulary comprises at least 10,000 words.

8. The method of claim 5, wherein the vocabulary comprises at least 50,000 words.

9. The method of claim 1, wherein determining the transcription based on the output of the recurrent neural network comprises determining the transcription without using a beam search technique.

10. The method of claim 1, wherein the speech recognition system is configured to not predict sub-word linguistic units.

11. The method of claim 1, wherein receiving the output of the recurrent neural network comprises receiving a set of output values from the recurrent neural network for each of multiple time steps, wherein each set of output values includes a probability of occurrence for each of multiple words in a vocabulary; and
wherein determining the transcription for the utterance based on the output of the recurrent neural network comprises determining, for each of multiple time steps, which word in the vocabulary has a highest probability of occurrence according to the set of output values for the time step.

12. The method of claim 1, wherein receiving the audio data comprises accessing audio data from an Internet resource.

13. The method of claim 1, further comprising providing the transcription as a caption for the audio data of the Internet resource.

14. A system comprising one or more computers and one or more storage devices storing instructions that are operable, when executed by the one or more computers, to cause the one or more computers to perform operations comprising:
receiving audio data representing an utterance of a speaker;
providing acoustic features of the audio data to a recurrent neural network trained using connectionist temporal classification to estimate likelihoods of occurrence of whole words based on acoustic feature input;
receiving output of the recurrent neural network generated in response to the acoustic features, the output indicating a likelihood of occurrence for each of multiple different words in a vocabulary;
determining a transcription for the utterance based on the output of the recurrent neural network; and
providing the transcription as output of the automated speech recognition system.

15. The system of claim 14, wherein the recurrent neural network is trained as a speaker-independent recognizer for continuous speech.

16. The system of claim 14, wherein the neural network is a bidirectional neural network that includes a plurality of forward-propagating long short-term memory layers, a plurality of backward-propagating long short-term memory layers, and a connectionist temporal classification output layer for classification decisions.

17. The system of claim 14, further comprising feature vectors that each include a set of mel-frequency coefficients for a different segment of the utterance;
wherein providing the acoustic features of the audio data to the recurrent neural network comprises:
providing the feature vectors as input to the recurrent neural network in a first sequence; and
providing the feature vectors as input to the recurrent neural network in a second sequence having a reversed order of the first sequence.

18. The system of claim 14, wherein the vocabulary comprises a predetermined set of words; and
wherein receiving the output of the recurrent neural network comprises:
for each of multiple time steps, receiving a set of probability scores that includes a probability score for each word in the predetermined set of words.

19. One or more non-transitory computer-readable storage media comprising instructions stored thereon that are executable by one or more processing devices and upon such execution cause the one or more processing devices to perform operations comprising:
receiving audio data representing an utterance of a speaker;
providing acoustic features of the audio data to a recurrent neural network trained using connectionist temporal classification to estimate likelihoods of occurrence of whole words based on acoustic feature input;
receiving output of the recurrent neural network generated in response to the acoustic features, the output indicating a likelihood of occurrence for each of multiple different words in a vocabulary;
determining a transcription for the utterance based on the output of the recurrent neural network; and
providing the transcription as output of the automated speech recognition system.

20. The one or more non-transitory computer-readable media of claim 19, wherein the recurrent neural network is trained as a speaker-independent recognizer for continuous speech.
